(19) United States
(12) Patent Application Publication
(10) Pub. No.: US 2025/0358223 A1
(43) Pub. Date: Nov. 20, 2025

(54) METHODS, ARCHITECTURES, APPARATUSES AND SYSTEMS FOR IP PACKET HANDLING USING MULTI-HOP RELAYING

(71) Applicant: InterDigital Patent Holdings, Inc., Wilmington, DE (US)

(72) Inventors: Jung Je Son, Warrington, PA (US); Michelle Perras, Montréal (CA); Taimoor Abbas, Sainte-Julie (CA); Samir Ferdi, Kirkland (CA)

(21) Appl. No.: 18/665,828

(22) Filed: May 16, 2024

(51) Int. Cl. H04L 45/741; H04L 45/00; H04L 45/16

(52) U.S. Cl. CPC H04L 45/741; H04L 45/16; H04L 45/26

(57) ABSTRACT

Procedures, methods, architectures, apparatuses, systems, devices, and computer program products for IP packet handling in multi-hop relay environments. A first relay device receives, from a wireless transmit/receive unit, WTRU, a first communication request comprising an identifier of the WTRU, information indicative of a service provided by an end relay device, and an identifier of the end relay device, transmits, to a second relay device, a second communication request comprising a first identifier of the first relay device and information indicative of the service provided by the end relay device, the identifier of the WTRU and the identifier of the end relay device, receives, from the second relay device, a first communication accept message comprising an identifier of the second relay device, the first identifier of the first relay device and information indicative of the service provided by the end relay device, the identifier of the WTRU and the identifier of the end relay device, transmits, to the WTRU, a second communication accept message comprising a second identifier of the first relay device, receives, from the WTRU or from the second relay device, a message including the identifier of the WTRU and information indicative of an IP address of the WTRU, receives an IP packet, and based on whether a source IP address or a destination IP address of the IP packet corresponds to the IP address of the WTRU, and forwards the IP packet to the second relay device or to the WTRU.

### BACKGROUND

The present disclosure is generally directed to the fields of communications, software and encoding, including, for example, to methods, architectures, apparatuses, systems directed to IP packet handling in multi-hop relay environments.

### SUMMARY

In a first aspect, the present principles are directed to a method at a first relay device, the method comprising receiving, from a wireless transmit/receive unit, WTRU, a first communication request comprising an identifier of the WTRU, information indicative of a service provided by an end relay device, and an identifier of the end relay device, transmitting, to a second relay device, a second communication request comprising a first identifier of the first relay device and information indicative of the service provided by the end relay device, the identifier of the WTRU and the identifier of the end relay device, receiving, from the second relay device, a first communication accept message comprising an identifier of the second relay device, the first identifier of the first relay device and information indicative of the service provided by the end relay device, the identifier of the WTRU and the identifier of the end relay device, transmitting, to the WTRU, a second communication accept message comprising a second identifier of the first relay device, receiving, from the WTRU or from the second relay device, a message including the identifier of the WTRU and information indicative of an IP address of the WTRU, receiving an IP packet, and based on whether a source IP address or a destination IP address of the IP packet corresponds to the IP address of the WTRU, forwarding the IP packet to the second relay device or to the WTRU

In a second aspect, the present principles are directed to a first relay device comprising at least one processor configured to receive, from a wireless transmit/receive unit, WTRU, a first communication request comprising an identifier of the WTRU, information indicative of a service provided by an end relay device, and an identifier of the end relay device, transmit, to a second relay device, a second communication request comprising a first identifier of the first relay device and information indicative of the service provided by the end relay device, the identifier of the WTRU and the identifier of the end relay device, receive, from the second relay device, a first communication accept message comprising an identifier of the second relay device, the first identifier of the first relay device and information indicative of the service provided by the end relay device, the identifier of the WTRU and the identifier of the end relay device, transmit, to the WTRU, a second communication accept message comprising a second identifier of the first relay device, receive, from the WTRU or from the second relay device, a message including the identifier of the WTRU and information indicative of an IP address of the WTRU, receive an IP packet, and based on whether a source IP address or a destination IP address of the IP packet corresponds to the IP address of the WTRU, forward the IP packet to the second relay device or to the WTRU.

In a third aspect, the present principles are directed to a method at a second relay device, the method comprising receiving, from a first relay device, a second communication request comprising an identifier of the first relay device and information indicative of a service provided by an end relay device, an identifier of a WTRU and an identifier the end relay device, transmitting, to the end relay device, a third communication request comprising a first identifier of the second relay device and information indicative of the service provided by the end relay device, the identifier of the WTRU and the identifier the end relay device, receiving, from the end relay device, a third communication accept message comprising an identifier of the end relay device and the first identifier of the second relay device, transmitting, to the first relay device, a first communication accept message comprising the identifier of the first relay device and a second identifier of the second relay device, receiving, from the end relay device or from the first relay device, a message including the identifier of the WTRU and information indicative of an IP address of the WTRU, receiving an IP packet, and based on whether a source IP address or a destination IP address of the IP packet corresponds to the IP address of the WTRU, forwarding the IP packet to the first relay device or to the end relay device.

In a fourth aspect, the present principles are directed to a second relay device comprising at least one processor configured to receive, from a first relay device, a second communication request comprising an identifier of the first relay device and information indicative of a service provided by an end relay device, an identifier of a WTRU and an identifier the end relay device, transmit, to the end relay device, a third communication request comprising a first identifier of the second relay device and information indicative of the service provided by the end relay device, the identifier of the WTRU and the identifier the end relay device, receive, from the end relay device, a third communication accept message comprising an identifier of the end relay device and the first identifier of the second relay device, transmit, to the first relay device, a first communication accept message comprising the identifier of the first relay device and a second identifier of the second relay device, receive, from the end relay device or from the first relay device, a message including the identifier of the WTRU and information indicative of an IP address of the WTRU, receive an IP packet, and based on whether a source IP address or a destination IP address of the IP packet corresponds to the IP address of the WTRU, forward the IP packet to the first relay device or to the end relay device.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example architecture model with a Proximity Services (ProSe) UE-to-Network relay;

FIG. 3 illustrates connection of a remote UE to a network through a ProSe UE-to-Network Relay; and

FIG. 4 illustrates a method for multi-hop UE-to-NW Relay connection setup according to an embodiment of the present principles.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

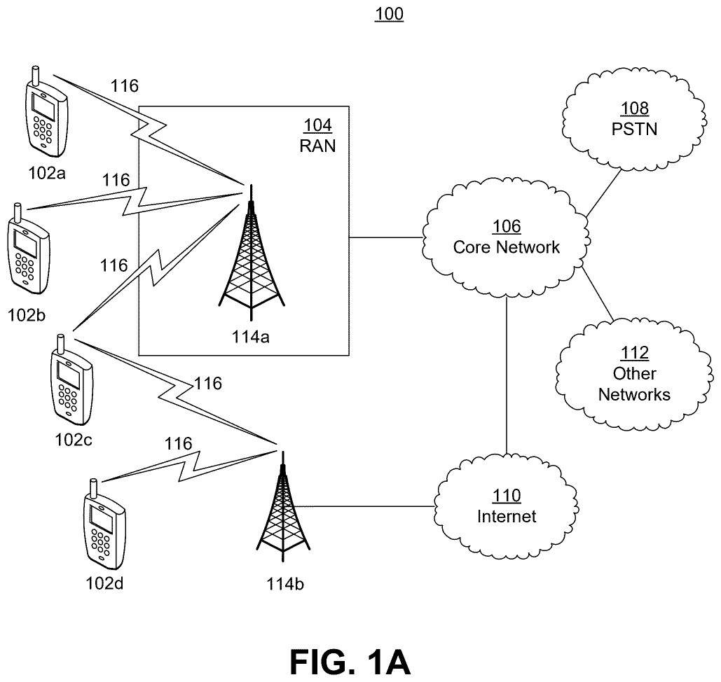

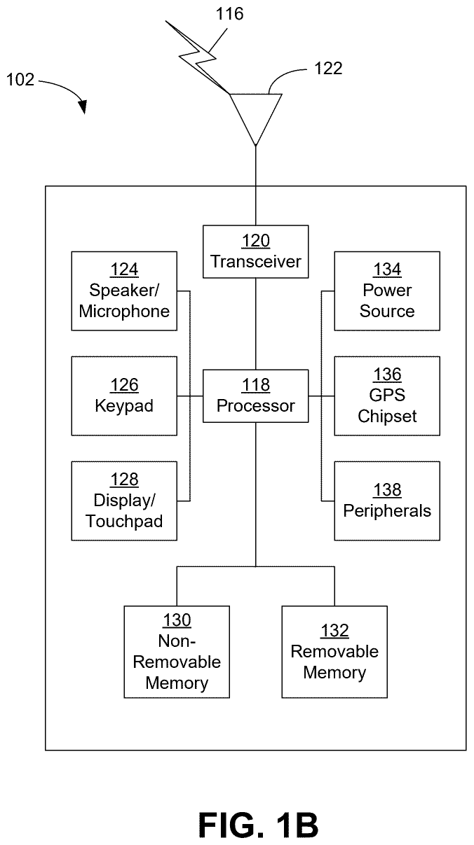

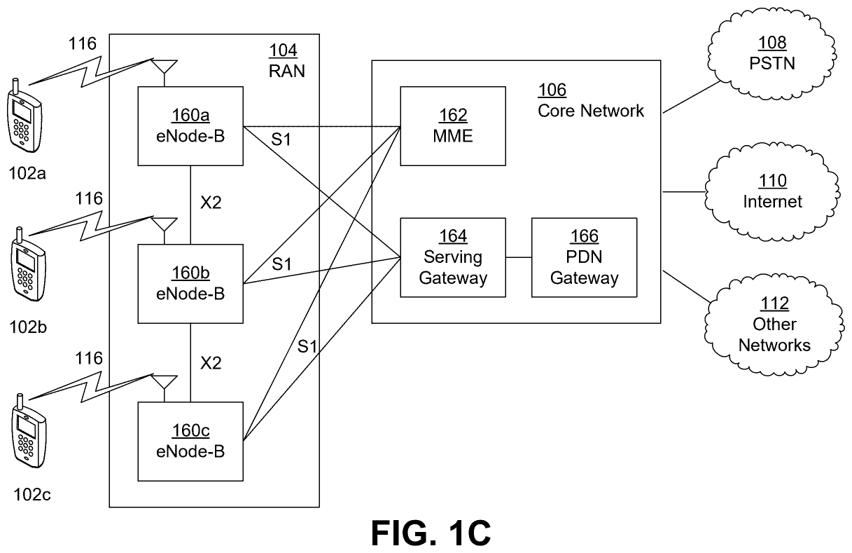

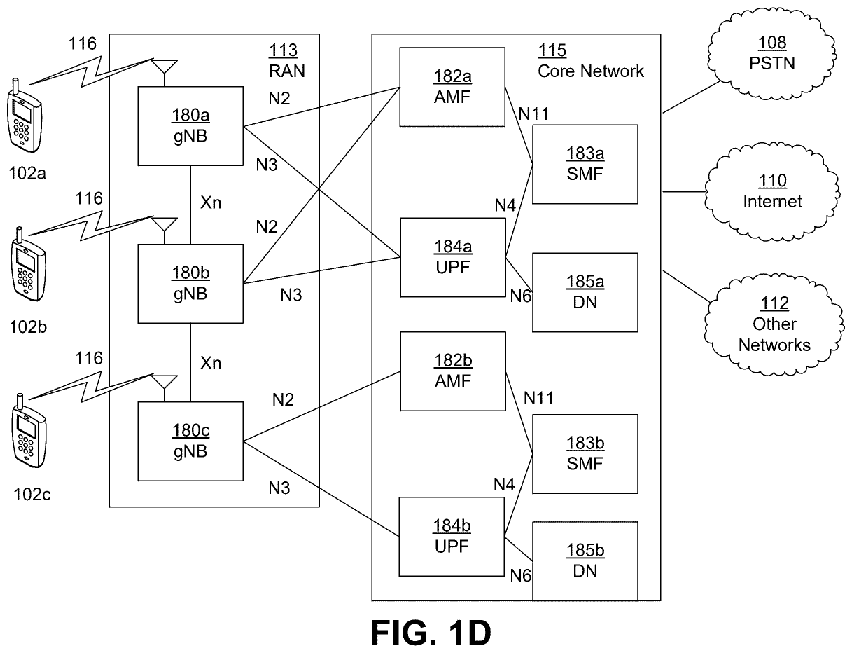

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (cNB), a Home Node-B (HNB), a Home cNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an cNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home cNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of cNode-Bs while remaining consistent with an embodiment. The cNode-Bs 160a, 160b, 160c may each include one or more transceivers for communicating with the WTRUs 102a, 102b, 102c over the air interface 116. In an embodiment, the cNode-Bs 160a, 160b, 160c may implement MIMO technology. Thus, the cNode-B 160a, for example, may use multiple antennas to transmit wireless signals to, and receive wireless signals from, the WTRU 102a.

Each of the cNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the cNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the cNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the SI interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHz and 20 MHz bandwidths in the TV white space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHZ, and/or other channel bandwidth operating modes. Carrier sensing and/or network allocation vector (NAV) settings may depend on the status of the primary channel. If the primary channel is busy, for example, duc to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as cNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, cNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (cMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

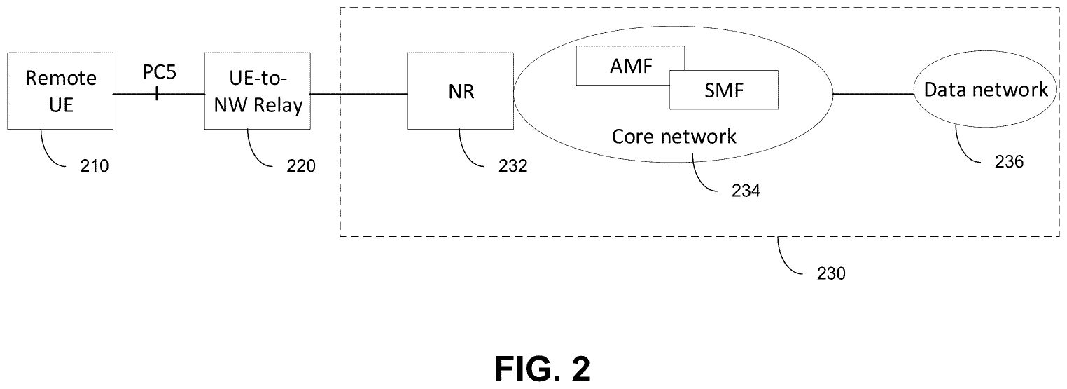

FIG. 2 illustrates an example architecture model with a Proximity Services, ProSe, UE-to-Network relay 220, which provides the functionality to support connectivity to the network 230 for remote UEs 210. The network 230 can for example include a NR (5G Radio Access technology) 232, a core network 234 including an Access and Mobility Management Function, AMF, and a Session Management Function, SMF, and a data network 236.

When the remote UE 210 is out of NR 232 coverage and cannot communicate with core network 234 directly (or is in NR 232 coverage but prefers to use PC5 for communication), the remote UE may discover and select a UE-to-Network relay 220. Then, the remote UE 210 establishes a PC5 session with the UE-to-Network Relay 220 that establishes a Protocol Data Unit, PDU, session (or Packet Data Network, PDN, connection in Evolved Packet Core, EPC) for the remote UE 210. After IP address/prefix allocation, the traffic between remote UE 210 and the network 230 is relayed by the UE-to-Network relay 220.

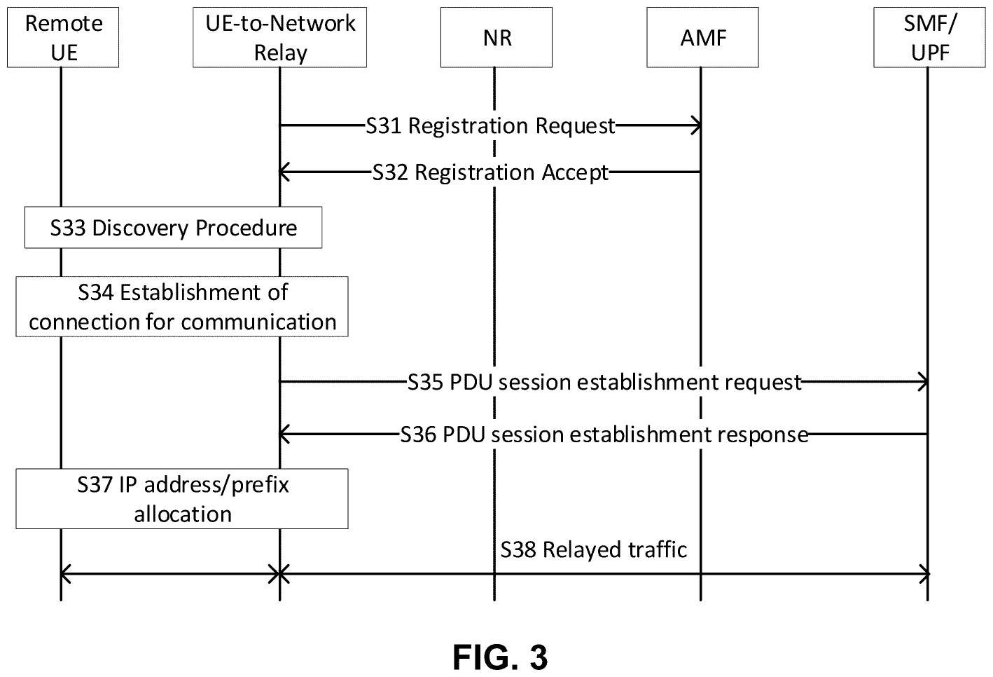

FIG. 3 illustrates connection of a remote UE to a network through a ProSe UE-to-Network Relay. In step S31, the UE-to-Network Relay sends a registration request to an AMF in the network. In step S32, providing the request is accepted, the AMF returns a registration accept message to the UE-to-Network Relay. In step S33, the remote UE goes through a discovery procedure with the UE-to-Network Relay and, in step S34, they establish a communication connection. In step S35, the UE-to-Network Relay sends a PDU session establishment request to a SMF that, if the request is accepted, in step S36, returns a PDU session establishment response. In step S37, the remote UE and the UE-to-Network Relay go through IP address/prefix allocation. Finally, in step S38, the remote UE sends traffic to the UE-to-Network Relay that relays the traffic to the SMF.

For 5G ProSe UE-to-Network Relay discovery, both so-called Model A and Model B discovery are supported. Model A uses a single discovery protocol message (Announcement). Model B uses two discovery protocol messages (Solicitation and Response). For Relay Discovery Additional Information, only Model A discovery is used.

In 3GPP, there are discussions to enhance UE-to-Network Relay, U2N Relay, and UE-to-UE Relay, U2U Relay, to support multi-hop connections. Multi-hop for U2N Relay would enable a remote UE to discover and communicate with a U2N Relay via one or more Intermediate, IM, Relays. Multi-hop U2U Relay would enable end UEs to discover and communicate with each via more than one U2U Relay. The multi-hop capability is deemed crucial for mission critical communications (e.g., first responders) and in general desired to enhance coverage (e.g., indoor).

For communication via a U2N Relay, as illustrated in step S37, the remote UE is allocated an IP address assigned by the U2N relay for IP-based data connection with other UEs.

For communication via a multi-hop U2N Relay, two IP address assignment methods for IM Relays are under study: either of the U2N relays assigns an IP address for all the IM relays in the path or the U2N relay and the IM Relay assigns an IP address to the next hop IM Relay.

For remote UE IP address assignment, only the U2N relay assigns the IP address of remote UE.

However, as there may be multiple remote UEs and multiple IM Relays connected to a U2N Relay, when IP traffic is exchanged between a remote UE and a U2N Relay via IM relays, it is not clear how the IM relays forwards the IP traffic to the correct receiver.

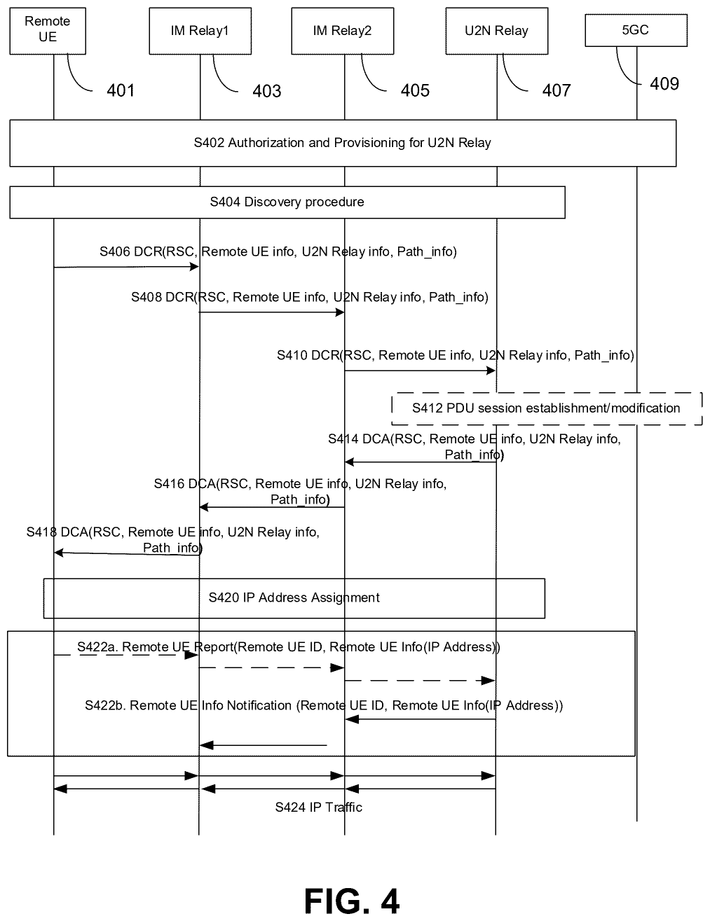

FIG. 4 illustrates a method for multi-hop UE-to-NW Relay connection setup according to an embodiment of the present principles.

In step S402, service authorization and parameter provisioning are performed for a U2N Relay 407, a first and a second IM Relay 403, 405 and a remote UE 401. In the parameter provisioning, Relay Service Code, RSC, supporting multi-hop U2N Relay service, default data link layer, L2, identifier, ID, for receiving and sending discovery messages, and other parameters are provided to the remote UE, the IM Relays, and the U2N Relay.

In step S404, the remote UE 401 performs discovery of a U2N Relay 407 and of a multi-hop path. The remote UE 401 obtains the User Info of U2N Relay 407 and an ordered list of User Info of IM Relays 403, 405 as Path_Info between the remote UE 401 and the U2N Relay 407 during the discovery procedure. In the illustrated example method, IM Relay 1 403 and IM Relay2 405 are discovered as multi-hop path between the remote UE 401 and the U2N Relay 407. The User Info of the remote UE, the U2N Relay, and the IM Relay(s) respectively indicate information that can be used as an identifier of the entity for discovery, connection setup and connection management of a multi-hop U2N relay network.

During the Discovery procedure, the remote UE 401 may acquire L2 ID of IM Relay 1 403, IM Relay1 403 may acquire L2 ID of IM Relay2 405, and IM Relay2 405 may acquire L2 ID of the U2N Relay 407, where the L2 IDs may be used for sending unicast signalling message (e.g. DCR (Direct Communication Request)). Each UE may locally store the acquired L2 IDs and related path information in a mapping table.

In step S406, based on the result of the discovery procedure, the remote UE 401 may select a U2N relay 407 and a multi-hop path, and the remote UE 401 may send to IM Relay 1 403 a multi-hop Communication Request for U2N Relay service, which includes a RSC (Relay Service Code) identifying the service provided by U2N Relay, User Info of remote UE, User Info of U2N Relay, information about the selected path (so called path info) (e.g. an ordered list of User Info of the IM Relay(s)).

When sending DCR for multi-hop Communication Request, as source L2 ID, the remote UE 401 may use a Layer 2 ID that it used during the discovery procedure in step S404 or a newly selected Layer 2 ID.

When sending DCR for multi-hop Communication Request, as destination L2 ID, the remote UE 401 may use the L2 ID of IM Relay1 403 which is known as result of the discovery procedure in step S404 or a L2 ID that was preconfigured or provisioned in step S402.

In step S408, upon reception of DCR from the remote UE 401, IM Relay1 403 may, based on multi-hop path information and User Info of the U2N Relay 407, update the mapping table to update the L2 IDs and selected path info (if it is previously stored in IM Relay1's mapping table and any of the input is updated in S406), otherwise it may create a new mapping table for the respective Remote UE and U2N relay UE, if no mapping table exists. IM Relay1 403 may send a multi-hop Communication Request for U2N Relay service, which includes a RSC identifying the service provided by the U2N Relay 407, User Info of the remote UE 401, User Info of the U2N Relay 407, information about the selected path (so called “path info”) (e.g. an ordered list of User Info of the IM Relay(s)).

When sending DCR for multi-hop Communication Request, as source L2 ID, IM Relay1 403 may use the Layer 2 ID which it used during the discovery procedure in step S404 or a newly selected Layer 2 ID.

When sending DCR for multi-hop Communication Request, as destination L2 ID, IM Relay1 403 may use the L2 ID of IM Relay2 405 which is known following the discovery procedure in step S404 or L2 ID that was preconfigured or provisioned in step S402.

In step S410, upon reception of DCR from the IM Relay1 403, IM Relay2 405 may, based on multi-hop path information and User Info of U2N Relay, update the mapping table to update the L2 IDs and selected path info (if it is previously stored in IM Relay1's mapping table and any of the input is updated in S408), otherwise it may create a new mapping table for the respective Remote UE and U2N relay UE, if no mapping table exists. IM Relay2 405 may send a multi-hop Communication Request for U2N Relay service, which includes RSC (Relay Service Code) identifying the service provided by the U2N Relay 407, User Info of the remote UE 401, User Info of the U2N Relay 407, information about the selected path (so called “path info”) (e.g. an ordered list of User Info of IM Relay(s)).

When sending DCR for multi-hop Communication Request, as source L2 ID, IM Relay2 405 may use the Layer 2 ID it used during the discovery procedure in step S404 or a newly selected Layer 2 ID.

When sending DCR for multi-hop Communication Request, as destination L2 ID, IM Relay2 405 may use the L2 ID of U2N Relay 407 which is known as result of the discovery procedure in step S404 or a L2 ID that was preconfigured or provisioned in step S402.

In step S412, upon reception of the multi-hop Communication Request, the U2N relay 407 may verify the request from the remote UE 401 via the IM relays 403, 405.

In case there is no PDU session for serving the U2N relay service associated with the RSC, the U2N relay 407 may perform a PDU session establishment procedure for relaying service represented by RSC. In case there is an established PDU session for the RSC, the U2N relay 407 may, if needed, perform a PDU session modification procedure for serving the remote UE 401.

In step S414, upon determination that the multi-hop communication request is accepted, the U2N Relay 407 responds with a multi-hop Communication Accept message (e.g., DCA (Direct Communication Accept)), which includes RSC, User Info of the remote UE 401, User Info of the U2N Relay 407, and path info.

When sending DCA for multi-hop Communication Accept, as source L2 ID, the U2N Relay 407 uses the Layer 2 ID it used during the discovery procedure in step S404 or a newly selected Layer 2 ID.

When sending DCA for multi-hop Communication Accept, as destination L2 ID, the U2N Relay 407 uses the L2 ID of IM Relay2 405 which was used as source L2 ID of IM Relay2 405 in step S410.

The source L2 ID and the destination L2 ID used in step S414 will be stored, e.g., in the mapping table, at the U2N Relay 407 and the IM Relay2 405, as the L2 ID of the U2N Relay 407 and the L2 ID of IM Relay2 405, for a unicast link between them, where the link will be used for forwarding traffic to or from the remote UE 401.

In another embodiment, U2N Relay 407 may be unable to establish a PDU session. In this case, it responds with a multi-hop Communication Reject message. The procedure remains the same as for the multi-hop Communication Accept message but an additional parameter such as a reject cause code will be provided to the remote UE 401. In case a reject message is sent, in the description of the following steps, the multi-hop Communication Accept message is replaced by multi-hop Communication Reject message.

In step S416, upon reception of the multi-hop Communication Accept message from the U2N Relay 407, IM Relay2 405 may send a multi-hop Communication Accept message to IM Relay1 403. The Communication Accept message may include the remote UE's User Info, the U2N Relay's User Info, a list of IM Relays' user info along the route, assigned end-to-end (E2E) Quality of Service (QOS) information (between the remote UE and the U2N Relay UE via IM Relays) and per-hop QoS information (between peer UEs sending and receiving the DCA message).

When sending DCA for multi-hop Communication Accept, as source L2 ID, IM Relay2 405 may use the Layer 2 ID it used during the discovery procedure in step S404 or a newly selected Layer 2 ID.

When sending DCA for multi-hop Communication Accept, as destination L2 ID, IM Relay2 407 uses the L2 ID of IM Relay1 which was used as source L2 ID of IM Relay1 in step S408.

The source L2 ID and the destination L2 ID used in step S416 will be stored at IM Relay2 405 and IM Relay1 403, as L2 ID of IM Relay2 and L2 ID of IM Relay1, for unicast link between them, which will be used for forwarding traffic to or from the remote UE 401.

In step S418, upon reception of the multi-hop Communication Accept message from IM Relay2 405, IM Relay1 403 may send a multi-hop Communication Accept message to the remote UE 401.

When sending DCA for multi-hop Communication Accept, as source L2 ID, IM Relay1 403 may use the Layer 2 ID it used during the discovery procedure in step S404 or a newly selected Layer 2 ID.

When sending DCA for multi-hop Communication Accept, as destination L2 ID, IM Relay 1 403 uses the L2 ID of the remote UE 401 which was used as source L2 ID of the remote UE in step S406.

The source L2 ID and the destination L2 ID used in step S418 will be stored at IM Relay 1 403 and remote UE 401, as L2 ID of IM Relay1 and L2 ID of remote UE, for unicast link between them, which will be used for forwarding traffic to or from the remote UE 401.

As a result of steps S403-S418 of the multi-hop Communication setup method, the remote UE 401, IM Relay 1 403, IM Relay2 405, and the U2N Relay 407 store, e.g., in the mapping table at each entity, the path info for the path between the remote UE 401 and the U2N Relay 407.

In step S420, the U2N relay 407 may allocate to the remote UE 401 an IPV6 prefix or IPv4 address (including NAT case) for IP PDU Session Type and IP traffic over PC5 reference point.

In step S422a, upon being assigned an IP address by the U2N Relay 407 or self-allocating an IP address based on the informed IPv6 prefix from U2N Relay 407, the remote UE 401 may send a Remote UE Report including remote UE ID (i.e., user info of remote UE), remote UE info which includes the IP address of remote UE 401, user info of the U2N Relay 407 and path information (i.e. User Info of IM Relay 1 403 and User Info of IM Relay2 405) to inform IM Relays about IP address update of the remote UE 401.

The Remote UE Report from the remote UE 401 is forwarded based on the path information to IM Relay1 403, IM Relay2 405, and, optionally, the U2N Relay 407.

Instead of step S422a, in step S422b, the U2N Relay 407 may send a Remote UE Information Notification including remote UE ID (i.e. user info of remote UE 401), remote UE info which includes the IP address of remote UE 401, user info of the U2N Relay 407 and path information (i.e. User Info of IM Relay1 403 and User Info of IM Relay2 405).

The remote UE Information Notification is forwarded to IM Relay1 403 and IM Relay2 405 based on the path info.

Upon reception of the Remote UE Report or the Remote UE Info notification, IM Relay1 403, IM Relay2 405, and, optionally, the U2N Relay 407 store the IP address of the remote UE 401 which will be used together with path information between the remote UE 401 and the U2N Relay 407 for forwarding traffic.

In step S424, when receiving an IP packet, IM Relay 1 403 and IM Relay2 405 may detect that the IP packet is from the remote UE 401 or for the remote UE 401 by comparing the included IP address and the stored remote UE's IP address. In case it is detected that the traffic is from the remote UE 401 or for the remote UE 401, IM Relay1 403 and IM Relay2 405 may forward the traffic to another entity (e.g. the other IM Relay) based on the path information and stored L2 IDs. For example, in case of an IP packet from the remote UE 401, IM Relay1 403 may forward the packet to IM Relay2 405 that in turn may forward it to the U2N Relay 407. For example, in case of an IP packet for the remote UE 401, IM Relay2 405 may forward the packet to IM Relay1 403 that in turn may forward it to the remote UE 401.

In case there is an existing PC5 connection between IM Relay1 403 and IM Relay2 405, and between IM Relay2 405 and the U2N Relay 407, a Link modification Request and a corresponding Response are exchanged between IM Relay1 403 and IM Relay2 405, and between IM Relay2 405 and the U2N Relay 407 to add a connection for the remote UE 401 instead of DCR and DCA in steps S408, S410, S414 and S416. In this case, the existing unicast source L2 IDs and destination L2 IDs are reused at IM Relay1 403, IM Relay2 405, and the U2N Relay 407.

FIG. 4 illustrates an example with two IM Relays, but it will be appreciated that the present principles extend to a greater number of IM Relays in a path. As an example, a third IM Relay, IM Relay 3, could be located between IM Relay1 and IM Relay 2. In such a system, IM Relay3 would receive the receive, from a first of the other IM Relays, a multi-hop Communication Request for U2N Relay service addressed to itself, and send, to a second of the other IM Relays, its own multi-hop communication request (corresponding to step S408 in FIG. 4 ‘split in two’) with the corresponding L2 IDs. Similarly, IM Relay3 would receive a multi-hop Communication Accept message from the second of the two IM Relays and send its own multi-hop Communication Accept message to the first of the two IM Relays (corresponding to step S416 in FIG. 4 ‘split in two’). Upon reception of an IP packet, IM Relay3 can determine, based on the included IP address, to which IM Relay it should forward the IP packet (much as described with reference to step S424 in FIG. 4.

IP address assignment messages can be handled in different ways.

For an IP Address assignment message such as a DHCP Request/Response, a Router Solicitation message, or a Router Advertisement message, the remote UE 401 and the U2N Relay 407 may send the message using link local IP address as source IP address and multicast IP address as destination IP address.

When receiving the message, the IM Relays 403, 405 should be able to detect whether the message is from the remote UE 401, from the U2N Relay 407, or if the message is forwarded from another IM Relay.

In order to detect the messages, the User Info of the remote UE 401 or the User Info of the U2N Relay 407 may be included in the PC5 message (for example, as an extended header).

When receiving an IP packet for IP Address assignment, IM Relays 403, 405 may decode the PC5 message header and, based on the included user info of the remote UE 401 or the user info of the U2N relay 407, detect whether the IP packet should be forwarded to the U2N Relay 407 or to the remote UE 401. Based on the path information, if the IP packet is from the remote UE 401, the IM Relay may forward the message to the next hop IM Relay toward the U2N Relay 407 or to the U2N Relay 407 if it is at the end point of the next hop. Based on the path information, if the packet is from the U2N Relay 407, the IM Relay forwards the message to the next hop IM Relay toward the remote UE 401 or to the remote UE if it is at the end point of the next hop.

In an embodiment, the IM Relays may decode the content of the IP Address assignment message. If the user info of the remote UE 401 or the user info of the U2N Relay 407 is included in the IP Address assignment message, an IM Relay may detect whether it is from the remote UE 401 or from the U2N Relay 407, and may forward the message to the proper entity based on the stored path information.

In another embodiment, in case a link local address is included in the IP Address assignment message, this address may be associated with the received source L2 ID. Based on the received L2 ID, the stored L2 ID information and path information, IM Relays may determine whether it should be forwarded to another IM relay or be discarded. For example, after storing the link local address as the remote UE's address based on the received source L2 ID, if IM Relay receives another IP Address assignment message including the same link local address from another IM Relay (which is detected based on the stored L2 ID information), then the IM Relay may discard the message as it may be the message which is forwarded by the IM Relay that received the original message from the remote UE 401.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-ID. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency trade-offs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method at a first relay device, the method comprising:
receiving, from a wireless transmit/receive unit, WTRU, a first communication request comprising an identifier of the WTRU, information indicative of a service provided by an end relay device, and an identifier of the end relay device;
transmitting, to a second relay device, a second communication request comprising a first identifier of the first relay device and the information indicative of the service provided by the end relay device, the identifier of the WTRU and the identifier of the end relay device;
receiving, from the second relay device, a first communication accept message comprising an identifier of the second relay device, the first identifier of the first relay device and the information indicative of the service provided by the end relay device, the identifier of the WTRU and the identifier of the end relay device;
transmitting, to the WTRU, a second communication accept message comprising a second identifier of the first relay device;
receiving, from the WTRU or from the second relay device, a message including the identifier of the WTRU and information indicative of an IP address of the WTRU;
receiving an IP packet; and
based on whether a source IP address or a destination IP address of the IP packet corresponds to the IP address of the WTRU, forwarding the IP packet to the second relay device or to the WTRU.

2. The method of claim 1, further comprising:
during a discovery procedure, providing an identifier of the first relay device to the WTRU and obtaining an identifier of the second relay device.

3. The method of claim 2, wherein:
the first identifier of the first relay device, the second identifier of the first relay device and the identifier of the second relay device are data link layer identifiers.

4. The method of claim 3, wherein:
the first identifier of the first relay device is identical to the second identifier of the first relay device.

5. The method of claim 1, wherein:
the first communication request further comprises information indicative of a selected path to the end relay device, the second communication request further comprises information indicative of the selected path to the end relay device.

6. The method of claim 2, further comprising:
obtaining, during the discovery procedure, an identifier of the WTRU.

7. A first relay device comprising at least one processor configured to:
receive, from a wireless transmit/receive unit, WTRU, a first communication request comprising an identifier of the WTRU, information indicative of a service provided by an end relay device, and an identifier of the end relay device;
transmit, to a second relay device, a second communication request comprising a first identifier of the first relay device and the information indicative of the service provided by the end relay device, the identifier of the WTRU and the identifier of the end relay device;
receive, from the second relay device, a first communication accept message comprising an identifier of the second relay device, the first identifier of the first relay device and the information indicative of the service provided by the end relay device, the identifier of the WTRU and the identifier of the end relay device;
transmit, to the WTRU, a second communication accept message comprising a second identifier of the first relay device;
receive, from the WTRU or from the second relay device, a message including the identifier of the WTRU and information indicative of an IP address of the WTRU;
receive an IP packet; and
based on whether a source IP address or a destination IP address of the IP packet corresponds to the IP address of the WTRU, forward the IP packet to the second relay device or to the WTRU.

8. The first relay device of claim 7, wherein the at least one processor is further configured to:
during a discovery procedure, provide an identifier of the first relay device to the WTRU and obtain an identifier of a second relay device.

9. The first relay device of claim 8, wherein:
the first identifier of the first relay device, the second identifier of the first relay device and the identifier of the second relay device are data link layer identifiers.

10. The first relay device of claim 9, wherein:
the first identifier of the first relay device is identical to the second identifier of the first relay device.

11. The first relay device of claim 7, wherein:
the first communication request further comprises information indicative of a selected path to the end relay device, and the second communication request further comprises information indicative of the selected path to the end relay device.

12. The first relay device of claim 8, wherein the at least one processor is further configured to:
obtain, during the discovery procedure, an identifier of the WTRU.

13. A method at a second relay device, the method comprising:
receiving, from a first relay device, a second communication request comprising an identifier of the first relay device and information indicative of a service provided by an end relay device, an identifier of a WTRU and an identifier of the end relay device;
transmitting, to the end relay device, a third communication request comprising a first identifier of the second relay device and the information indicative of the service provided by the end relay device, the identifier of the WTRU and the identifier of the end relay device;
receiving, from the end relay device, a third communication accept message comprising the identifier of the end relay device and the first identifier of the second relay device;
transmitting, to the first relay device, a first communication accept message comprising the identifier of the first relay device and a second identifier of the second relay device;
receiving, from the end relay device or from the first relay device, a message including the identifier of the WTRU and information indicative of an IP address of the WTRU;
receiving an IP packet; and
based on whether a source IP address or a destination IP address of the IP packet corresponds to the IP address of the WTRU, forwarding the IP packet to the first relay device or to the end relay device.

14. The method of claim 13, further comprising:
during a discovery procedure, providing the first identifier of the second relay device to the first relay device and obtaining an identifier of the end relay device.

15. The method of claim 14, wherein:
the identifier of the first relay device, the first identifier of the second relay device and the second identifier of the second relay device are data link layer identifiers.

16. The method of claim 15, wherein:
the first identifier of the second relay device is identical to the second identifier of the second relay device.

17. A second relay device comprising at least one processor configured to:
receive, from a first relay device, a second communication request comprising an identifier of the first relay device and information indicative of a service provided by an end relay device, an identifier of a WTRU and an identifier the end relay device;
transmit, to the end relay device, a third communication request comprising a first identifier of the second relay device and the information indicative of the service provided by the end relay device, the identifier of the WTRU and the identifier the end relay device;
receive, from the end relay device, a third communication accept message comprising an identifier of the end relay device and the first identifier of the second relay device;
transmit, to the first relay device, a first communication accept message comprising the identifier of the first relay device and a second identifier of the second relay device;
receive, from the end relay device or from the first relay device, a message including the identifier of the WTRU and information indicative of an IP address of the WTRU;
receive an IP packet; and
based on whether a source IP address or a destination IP address of the IP packet corresponds to the IP address of the WTRU, forward the IP packet to the first relay device or to the end relay device.

18. The second relay device of claim 17, wherein the at least one processor is further configured to:
during a discovery procedure, provide the first identifier of the second relay device to the first relay device and obtain an identifier of the end relay device.

19. The second relay device of claim 18, wherein:
the identifier of the first relay device, the first identifier of the second relay device and the second identifier of the second relay device are data link layer identifiers.

20. The second relay device of claim 19, wherein:
the first identifier of the second relay device is identical to the second identifier of the second relay device.
